(19) United States
(12) Patent Application Publication
(10) Pub. No.: US 2013/0152313 A1
(43) Pub. Date: Jun. 20, 2013

(54) SINGLE LAYER DISSOLVABLE POUCHES CONTAINING STAIN-FIGHTING AGENTS

(71) Applicant: Dropps, Philadelphia, PA (US)

(72) Inventor: Jonathan Propper, Haverford, PA (US)

(73) Assignee: Dropps, Philadelphia, PA (US)

(21) Appl. No.: 13/714,850

(22) Filed: Dec. 14, 2012

Related U.S. Application Data
(60) Provisional application No. 61/570,387, filed on Dec. 14, 2011.

(51) Int. Cl. C11D 17/00

(52) U.S. Cl. CPC C11D 17/0039
USPC 8/137; 206/524.7; 206/232

(57) ABSTRACT

Water-soluble, single unit pouches containing a pre-measured amount of a solid bleaching agent, bleach activating agent, and stain-fighting enzymes that can be added to a volume of water to bleach and/or deodorize laundry or a surface are provided. Water-soluble, single unit pouches containing a pre-measured amount of a solid fabric softening agent and fragrance that can be added to a volume of water to soften a material are provided. Also provided are kits including the pouches, as well as methods for using such pouches for bleaching and/or softening a material or surface.

### CROSS REFERENCE TO RELATED APPLICATIONS

This application claims priority to U.S. Provisional Application No. 61/570,387, filed on Dec. 14, 2011, the contents of which are incorporated by reference herein, in their entirety and for all purposes.

### FIELD OF THE INVENTION

The invention relates generally to stain-fighting and odor-fighting products. More particularly, the invention relates to water soluble pouches containing a single use amount of a solid or liquid bleaching agent, bleach activator, and stain-fighting enzymes that can be added to a load of laundry in order to remove stains from and deodorize materials being washed, as well as methods for using the pouches. The pouches may also include a fabric softener, fragrance and/or detergent.

### INTRODUCTION

Various publications, including patents, published patent applications, technical articles, and scholarly articles, are cited throughout the specification. Each of these cited publications is incorporated by reference in this document, in its entirety and for all purposes.

Many commercially available fabric softening agents soften materials by coating the material with an oily film that makes the material feel soft to the touch, but which do not actually soften the material itself. Cationic softeners coat materials via electrostatic attraction to ions on the surface of the material. Examples of oil-based fabric softeners include quaternary ammonium salts such as dipalmitoylethyl hydroxyethylmonium methosulfate, as well as substituted amine salts, imidazolium, and alkoxy ammonium salts. Some oil-based fabric softeners are incompatible with certain materials.

The oily material, as well as the emulsifying agents, stabilizers, buffers, and other additives placed in oil-based fabric softeners may cause skin irritation in some individuals, and may negatively affect, for example, the absorbent capacity of towels, the wicking ability of athletic apparel, and the flame retardant properties of other materials. In addition, some oil-based fabric softeners can leave spots on clothing if poured directly onto the material, and thereby ruin the material. Some commercially available fabric softeners have avoided the use of oils, and have instead used silicone-based compounds that lubricate the materials. Other commercially available fabric softening agents have avoided the use of agents that coat materials, and instead have included micronized minerals that soften materials mechanically during agitation, for example, during a rinse cycle.

When using either an oil-based fabric softener, the user typically measures out a recommended amount of the softener, and then adds the softener to the laundry during the rinse cycle. The softener cannot be added to the wash cycle, or it will be washed away by the detergent, thereby lessening its desired softening effect, or could chemically interact with the surfactants used in the detergents. But adding a softener to the rinse cycle requires a second step in washing a load of laundry, and more importantly, requires that the user remember and be available to add softener during the rinse cycle, at least as concerns the use of top-loading washing machines.

Some more recently available commercial fabric softening products allow the user to place a fabric softener into the wash cycle along with the detergent, thereby avoiding the need to add the fabric softener during the rinse cycle. But these products still require that the user measure out a recommended amount of softener. Moreover, these products, which are typically in the form of solid crystals, are not suitable for use with the liquid loading tray of front-end washing machines that add liquid detergents, bleach, and other cleaning materials to the washing machine drum through the loading tray. Solid, mineral-based fabric softeners cannot be placed in a loading tray of a front-loading washing machine because they will not dissolve.

### SUMMARY OF THE INVENTION

The invention features single-use pouches that contain one or more of stain-fighting compositions, fabric-softening compositions, stain- or odor-fighting, fabric softening compositions, or cleaning compositions. The pouches are water-soluble and single-layered, and generally fabricated from polyvinyl alcohol. The pouch preferably comprises a body that defines a container portion, which contains the composition. A pouch may include multiple container portions, for example, with one container portion containing a stain-fighting composition and one container portion containing a fabric-softening composition, and in some aspects, with one container portion containing a detergent.

In some aspects, the container portion of the pouch contains a stain-fighting composition comprising about 60% to about 76% by weight of a bleaching agent, about 20% to about 30% by weight of a bleach activating agent, about 1% to about 9% of an enzyme that catalyzes the breakdown of an oil-based stain, and about 0.5% to about 2.5% of an enzyme that catalyzes the breakdown of a protein-based stain or a starch-based stain. The composition may comprise about 65% to about 70% of a bleaching agent, about 24% to about 26% of a bleach activating agent, about 4% to about 6% of an enzyme that catalyzes the breakdown of an oil-based stain, and about 1% to about 1.5% of an enzyme that catalyzes the breakdown of a protein-based stain or a starch-based stain. The composition may comprises about 68% of a bleaching agent, about 26% of a bleach activating agent, about 5% of an enzyme that catalyzes the breakdown of an oil-based stain, and about 1% of an enzyme that catalyzes the breakdown of a protein-based stain or a starch-based stain. Each agent and enzyme is preferably in solid form.

The bleaching agent is preferably sodium percarbonate, the bleach activating agent is preferably tetra-acetylethylenediamine, the enzyme that catalyzes the breakdown of an oil-based stain preferably comprises a lipase, and the enzyme that catalyzes the breakdown of a protein-based stain or a starch-based stain preferably comprises a protease, an amylase, a cellulase, or a combination thereof. The composition preferably does not include sodium carbonate. The stain-fighting composition may be contained in the pouch in an amount sufficient for one regular laundry cycle. The stain-fighting composition may be contained in the pouch in an amount sufficient for one high efficiency laundry cycle.

In some aspects, the container portion of the pouch contains a stain-fighting, fabric-softening composition comprising about 32% to about 36% by weight of a bleaching agent, about 11% to about 15% by weight of a bleach activating agent, about 2% to about 3% of an enzyme that catalyzes the breakdown of an oil-based stain, about 0.5% to about 0.9% of an enzyme that catalyzes the breakdown of a protein-based stain or a starch-based stain, about 47% to about 51% by weight of a fabric-softening, and about 0.5% to about 1.5% by weight of a fragrance absorbed into the fabric softening agent. Each component of the composition is preferably in solid form.

The bleaching agent is preferably sodium percarbonate, the bleach activating agent is preferably tetra-acetylethylenediamine, the enzyme that catalyzes the breakdown of an oil-based stain preferably comprises a lipase, and the enzyme that catalyzes the breakdown of a protein-based stain or a starch-based stain preferably comprises a protease, an amylase, a cellulase, or a combination thereof. The solid fabric softening agent may comprise bentonite, zeolite, or a combination thereof, and may be comprise particles about 1 mm to about 3 mm in size. The composition preferably does not include sodium carbonate. The fabric softening agent may comprise a dye so as to color the fabric softening particles. The fabric-softening composition may be contained in the pouch in an amount sufficient for one regular laundry cycle. The fabric-softening composition may be contained in the pouch in an amount sufficient for one high efficiency laundry cycle.

A pouch containing a stain- and odor-fighting composition and/or a pouch containing a stain-fighting, fabric-softening composition may be comprised in a laundry kit. The kit may include instructions for using the composition in a method for removing stains from/bleaching laundry, and/or a method for softening laundry. The kits may further comprise a pouch containing a detergent.

### DETAILED DESCRIPTION OF THE INVENTION

Various terms relating to aspects of the present invention are used throughout the specification and claims. Such terms are to be given their ordinary meaning in the art, unless otherwise indicated. Other specifically defined terms are to be construed in a manner consistent with the definition provided in this document.

As used herein, the singular forms “a,” “an,” and “the” include plural referents unless expressly stated otherwise.

Laundry includes, but is not limited to, any materials to be washed, cleaned, or softened, including articles of clothing, sheets and linens, blankets, tapestries, napkins, upholstery, towels, curtains, area rugs, stuffed animals, pillows, footwear, fabrics, and other fabric-based materials.

In some aspects, the invention features pouches and methods for removing stains from laundry or a surface. In some aspects, the invention features pouches and methods for softening, optionally imparting a desired scent into, and optionally, bleaching laundry, for example, for use in a washing machine. The pouches and methods may be used in household, commercial, or industrial applications.

In some aspects, a pouch is a single use pouch. The pouch may be fabricated out of any suitable material, and is preferably fabricated out of a water-soluble material. Thus, the pouch is preferably water soluble. Non-limiting examples of suitable materials for fabricating the pouch include polyvinyl alcohol, partially hydrolyzed polyvinyl acetate, and alginates.

The materials for the pouch may be formulated to particular water-solubility specifications, including partial or complete solubility in cold, lukewarm, warm, hot, or very hot water. The pouch preferably has a single layer of suitable materials, with the internal surface of the layer in contact with the contents of the pouch and with the external surface of the layer comprising the outermost portion of the pouch. The pouch may also have multiple layers, for example, two layers. The outer layer or layers may allow the pouch to maintain its structural integrity for longer periods of time, thereby substantially dissolving and releasing its contents later in a wash cycle. In some aspects, an outer layer may be formulated to allow the pouch to withstand higher water temperatures such as those that may be used during an early cleaning cycle, thereby allowing a pouch added early to a load of laundry to last until late in the overall cleaning cycle. The pouch is preferably not coated, although the pouch may be coated in some aspects.

The water solubility of the pouch, including the extent and rate of dissolution, may relate, in part, to the thickness of the pouch. The thickness may be a function of the number of layers. The thickness may be a function of the amount of the materials used, and in any event should be sufficient to give the pouch a degree of mechanical strength such that the pouch can be handled by a user without rupturing, leaking its contents, or dissolving in the user's hand. The thickness of the body may range from about 0.1 to about 2 mm, although smaller or larger thicknesses are possible. Preferred thicknesses may be about 0.2 mm, about 0.3 mm, about 0.5 mm, or about 1 mm. In some preferred aspects, the pouch is not coated with any additional materials.

A pouch may be formed, for example, from one or more sheets of a packaging material or from a tubular section of such material. In some aspects, the pouch may be formed from a single folded sheet of material or from two sheets of material, sealed together at the edges, for example, with an adhesive or by heat-sealing. The pouch may be prepared according to U.S. Pat. No. 6,037,319, including the materials and specifications set forth in that patent. The pouch may be manufactured in any suitable shape, including a substantially round, cylindrical, or rectangular shape.

The pouch preferably contains a pre-measured amount of a composition, including any composition described or exemplified herein. In some preferred aspects, the pouch contains a pre-measured amount of a stain- and odor-fighting composition comprising a bleaching agent in solid form, an oxidizing agent in solid form, and one or more stain fighting enzymes. In some preferred aspects, the pouch also contains a pre-measured amount of fabric softening agent in solid form, and a fragrance. In some preferred aspects, the pouch also contains a pre-measured amount of a surfactant in solid form. Preferably, the pouch is a single use pouch that dissolves in water and releases its contents into the water.

Thus, for example, a pouch may be manufactured and provided to a consumer in a single unit, ready-to-use form, with the bleaching agent, bleach activating agent, stain fighting enzymes, fabric softening agent, fragrance, and/or detergent in pre-measured amounts suitable for a regular wash cycle, suitable for a high efficiency wash cycle, or suitable for a large load cycle including load size for commercial laundry facilities. As well, a pouch may be manufactured and provided to a consumer in a single unit, ready-to-use form, with the bleaching agent, bleach activating agent, stain fighting enzymes, fabric softening agent, fragrance, and/or detergent in pre-measured amounts suitable for large, intense, or fixed stains. For applications including fabric softening, a pouch may be manufactured and provided to a consumer in a single unit, ready-to-use form, with the fabric softening agent and/or fragrance in pre-measured amounts suitable for imparting a high degree of softness, for imparting strong scents, for imparting weak scents, to a particular type of article being washed or for any particular consumer preferences. The amount of fragrance may be also be tailored for odor control applications. The amount of bleaching agent may also be tailored for disinfecting applications, and the fragrance may be a long-lasting fragrance.

In preferred embodiments, the pouch does not contain any liquids. Thus, it is preferable that the bleaching agent, bleach activating agent, stain fighting enzymes, fabric softening agent, fragrance, enzyme and/or surfactant are in a solid form. Nevertheless, the pouch may comprise any or all of the bleaching agent, bleach activating agent, stain fighting enzymes, fabric softening agent, fragrance, and/or surfactant in liquid form, or in a slurry form. By way of example, but not of limitation, a sold fabric softening agent may be suspended in a liquid bleaching agent and/or liquid surfactant.

In one aspect, the pouch comprises a stain-fighting pouch. The pouch contains a stain-fighting composition comprising a bleaching agent, a bleach activating agent, and one or more stain fighting enzymes each in an amount effective to fight stains. For example, the stain-fighting composition may comprise, may consist essentially of, or may consist of (weight %) about 60% to about 76% of a bleaching agent, about 20% to about 30% of a bleach activating agent, about 1% to about 9% of an enzyme that catalyzes the breakdown of an oil-based stain, and about 0.5% to about 2.5% of an enzyme that catalyzes the breakdown of a protein-based stain and/or a starch-based stain. The stain-fighting composition more preferably may comprise, may consist essentially of, or may consist of (weight %) about 65% to about 70% or about 67% to about 69% of a bleaching agent, about 24% to about 26% of a bleach activating agent, about 4% to about 6% of an enzyme that catalyzes the breakdown of an oil-based stain, and about 1% to about 1.5% of an enzyme that catalyzes the breakdown of a protein-based stain and/or a starch-based stain. The stain-fighting composition more preferably may comprise, may consist essentially of, or may consist of (weight %) about 68% of a bleaching agent, about 26% of a bleach activating agent, about 5% of an enzyme that catalyzes the breakdown of an oil-based stain, and about 1% of an enzyme that catalyzes the breakdown of a protein-based stain and/or a starch-based stain. In some detailed aspects, the stain-fighting composition may comprise, may consist essentially of, or may consist of (weight %) about 68.1% of a bleaching agent, about 25.5% of a bleach activating agent, about 5.1% of an enzyme that catalyzes the breakdown of an oil-based stain, and about 1.3% of an enzyme the catalyzes the breakdown of a protein-based stain and/or a starch-based stain. Each agent is preferably in solid form. The composition, when dissolved in water, preferably effervesces. The composition preferably does not contain sodium carbonate.

A pouch may contain, for example, about 60%, about 61%, about 62%, about 63%, about 64%, about 65%, about 66%, about 67%, about 68%, about 69%, about 70%, about 71%, about 72%, about 73%, about 74%, about 75%, or about 76% by weight of a bleaching agent. A pouch may contain, for example, about 20%, about 21%, about 22%, about 23%, about 24%, about 25%, about 26%, about 27%, about 28%, about 29%, or about 30% by weight of a bleach activating agent. A pouch may contain, for example, about 4%, about 5%, or about 6% by weight of an enzyme that catalyzes the breakdown of an oil-based stain. A pouch may contain, for example, about 0.5%, about 1%, or about 1.5% by weight of an enzyme that catalyzes the breakdown of a protein-based stain and/or a starch-based stain.

The bleaching agent may be colored, for example, to accommodate consumer preference. The bleaching agent may thus comprise about 0.05% to about 2% (by weight of the bleaching agent) of a dye, or may comprise about 0.05% to about 1% (by weight of the bleaching agent) of a dye. The dye may be any suitable dye that will not leech into the laundry and alter the color of the laundry, including a yellow, green, blue, purple, red, or orange dye. The bleaching agent may include both colored and uncolored particles. In some preferred aspects, the bleaching agent does not include any dye, or is white.

In any of the compositions described or exemplified herein, non-limiting examples of bleaching agents include chlorine-free and oxidative bleaching agents, with preferred examples including without limitation sodium perborate (sodium peroxyborate tetrahydrate), sodium percarbonate, sodium perphosphate, percarbamide, sodium persulfate, tetrasodium pyrophosphate, urea peroxide plus catalysts and activators, e.g., tetraacetylethylenediamine or sodium nonanoyloxybenzenesulfonate, calcium peroxide, zinc peroxide, sodium peroxide, carbamide peroxide, chlorine dioxide, bromate, and benzoyl peroxide, as well as mixtures thereof. Sodium percarbonate is highly preferred. In any of the compositions described or exemplified herein, non-limiting examples of a bleach activating agent may comprise a neutral, anionic, or cationic bleach activator, with preferred examples including without limitation tetra-acetylethylenediamine (TAED), nonanoyl benzene sulfonic acid (NOBS), or N-[4-(triethylammoniomethyl)benzoyl] butyrolactam chloride (TBBC). TAED is highly preferred. In any of the compositions described or exemplified herein, non-limiting examples of an enzyme that catalyzes the breakdown of an oil-based stain may comprise any class or specific enzyme suitable for this purpose, including a lipase enzyme. In some aspects, a protease or amylase enzyme may also be used to catalyze the breakdown of an oil-based stain. In any of the compositions described or exemplified herein, non-limiting examples of an enzyme that catalyzes the breakdown of a protein-based stain and/or a starch-based stain may comprise any class or specific enzyme suitable for this purpose, including a protease, amylase, or cellulase. In some aspects, a lipase may also be used to catalyze the breakdown of a protein-based and/or a starch-based stain. An enzyme may comprise a lyophilized powder that is reconstituted and activated upon rehydration.

In some aspects, the bleaching agent is a chlorine-based bleaching agent. Non-limiting examples of chlorine-based bleaching agents include sodium hypochlorite, calcium hypochlorite, lithium hypochlorite, chlorinated isocyanurates, isocyanuric acid, dichlorodimethyl hydantoin, chlorinated phosphates, and chloramines, as well as mixtures thereof.

In one aspect, the pouch comprises a fabric softening pouch. The pouch contains a fabric softening composition comprising a fabric softening agent and a fragrance in an amount effective to soften laundry and to impart a desired scent into the laundry. For example, the fabric-softening composition may comprise, may consist essentially of, or may consist of (weight %) about 90% to about 99% of a fabric softening agent and about 1% to about 10% of a fragrance. The fabric-softening composition more preferably may comprise, may consist essentially of, or may consist of (weight %) about 94% to about 99% of a fabric softening agent and about 1% to about 6% of a fragrance. The fabric-softening composition more preferably may comprise, may consist essentially of, or may consist of (weight %) about 98% to about 99% of a fabric softening agent and about 1% to about 2% of a fragrance. The fabric softening agent is preferably in solid form. The fragrance may be a composition comprising a fragrance. The fragrance may be absorbed into, coated onto, or otherwise impregnated into the solid fabric softening agent; essentially the fabric softening agent functions as a carrier for the fragrance.

A pouch may contain, for example, about 91%, about 92%, about 93%, about 94%, about 95%, about 96%, about 97%, about 98%, or about 99% by weight of a fabric softening agent. A pouch may contain, for example, about 9%, about 8%, about 7%, about 6%, about 5%, about 4%, about 3%, about 2%, about 1%, or about 0.5% by weight of a fragrance. The pouches are suitable for use with any fabric softening agent.

In any of the compositions described or exemplified herein, the fabric softening agent preferably comprises a clay or a mineral. Some non-limiting examples of suitable agents include bentonite (montmorillonite) and zeolite, as well as mixtures thereof. The bentonite may comprise one or more of sodium-, potassium-, calcium-, or aluminum-bentonite.

The clay or mineral fabric softening agent is preferably in particle form, and the particles may be of any suitable size, and are preferably substantially uniform in size. For example, the fabric softener may be in the form of a powder, or may otherwise be micronized. The fabric softener particles may be uniform in size, or may comprise variable sizes. The particles may be from about 0.05 mm to about 5 mm in size, from about 0.05 mm to about 5 mm in size, from about 0.1 to about 2 mm in size, from about 1 to about 2 mm in size, from about 1 to about 3 mm in size, from about 2 to about 4 mm in size, or from about 0.5 to about 2 mm in size. The clay or mineral fabric softening agent particles may comprise sugars, starches, builders, or other filling materials.

The fabric softening agent is preferably in solid form, but in some aspects, a pouch contains a solid fabric softening agent suspended in a liquid composition comprising a fragrance and a suitable carrier. The carrier may comprise a suitable hydrophobic vehicle, including an organic solvent, oil, or alcohol such as ethanol, isopropanol, or a polyol. Non-limiting examples of suitable polyols include glycol such as ethylene glycol, polyethylene glycol, 1,2-propane diol, propylene glycol, butylene glycol, neopentyl glycol, and hexylene glycol, as well as glycerol, mannitol, maltitol, sorbitol, erythritol, xylitol, glucose, fructose, lactose and erythritan. The carrier may comprise an aqueous vehicle such as water. The composition may comprise an emulsion, including an oil-in-water or water-in-oil emulsion.

In aspects where the fabric softening agent and the fragrance are in liquid form, the pouch material preferably can withstand the water content of liquids contained within the pouch. Preferably, the pouch material can withstand water content of about 10% or less, about 7% or less, about 5% or less, or about 2% or less in the liquid fabric softener, fragrance, or composition thereof. Yet, the pouch readily dissolves when immersed in water or aqueous cleaning solutions, for example, during the wash cycle or the rinse cycle.

The pouches containing a fabric softening agent are suitable for use with any desired fragrance, aroma, essential oil, or composition comprising a fragrance, aroma, or essential oil. The fragrance may serve to control odors, as well as to impart desired scents into materials. Non-limiting examples of scents that may be used in accordance with any composition described herein include cherry, berry, clove, apple, pear, banana, orange, grapefruit, lemon, lime, peach, grape, lavender, lemongrass, coconut, mint, rosemary, menthol, tea tree, cedarwood, pine, orchid, eucalyptus, litsea, mentha, cocoa, vanilla, and any other scent a consumer prefers, as well as combinations thereof.

A solid fabric softening agent may be colored, for example, to accommodate consumer preference. The fabric softening agent may thus comprise about 0.05% to about 2% (by weight of the fabric softening agent) of a dye, or may comprise about 0.05% to about 1% (by weight of the fabric softening agent) of a dye. The dye may be any suitable dye that will not leech into the laundry and alter the color of the laundry, including a yellow, green, blue, purple, red, or orange dye. The fabric softening agent may include both colored and uncolored particles. If used, the colors may “match” the fragrance, such as an orange color for an orange scent, a yellow color for a lemon scent, or a purple color for an orchid scent. In some aspects, the fabric softening agent does not include any dye. If used, the colors may be different from the color(s) of the bleaching agent.

In some aspects, the pouch comprises both a stain-fighting and a fabric softening pouch. Thus, for example, the pouch may contain a stain-fighting, fabric-softening composition comprising a bleaching agent, a bleach activating agent, and one or more stain fighting enzymes each in an amount effective to fight stains, as well as a fabric softening agent and a fragrance in an amount effective to soften laundry and to impart a desired scent into the laundry. The pouch may comprise a single chamber containing the composition. The pouch may comprise separate chambers, with one chamber containing a composition comprising a bleaching agent, a bleach activating agent, and one or more stain fighting enzymes, and the other chamber containing a composition comprising a fabric softening agent and a fragrance. In embodiments where the pouch comprises separate chambers, the composition comprising a bleaching agent, a bleach activating agent, and one or more stain fighting enzymes, and the composition comprising the fabric softening agent and fragrance may respectively comprise the compositions described above. In embodiments where they stain-fighting and fabric softening compositions are combined, the amount of each constituent of the composition may be as set forth below.

In some aspects, the pouch may contain a cleaning composition comprising a bleaching agent, a bleach activating agent, and one or more stain fighting enzymes each in an amount effective to fight stains, as well as a fabric softening agent and a fragrance in an amount effective to soften laundry and to impart a desired scent into the laundry, as well as a surfactant or detergent in an amount effective to clean laundry. The pouch may comprise separate chambers, with one chamber containing a composition comprising a bleaching agent, a bleach activating agent, and one or more stain fighting enzymes, one chamber containing a composition comprising a fabric softening agent and a fragrance, and one chamber containing a composition comprising a surfactant or detergent. In embodiments where the pouch comprises separate chambers, the composition comprising a bleaching agent, a bleach activating agent, and one or more stain fighting enzymes, and the composition comprising the fabric softening agent and fragrance may respectively comprise the compositions described above, and the composition comprising the surfactant or detergent may comprise the composition described below. In embodiments where they stain-fighting, fabric softening, and detergents compositions are combined, the amount of each constituent of the composition may be as set forth below.

Each composition is preferably formulated to be compatible with the pouch, without compromising the integrity of the pouch, weakening the pouch, or dissolving the pouch over time during shelf storage. In the pouch, each composition is preferably contained within a single layer of material having an internal surface directly contacting the composition. In some aspects, the pouch may also have multiple layers, for example two layers. Where multiple layers are present, the composition is preferably contained within the inner layer of material having an internal surface directly contacting the composition and an external surface in contact with an internal surface of the next layer of material. It is preferred that the pouch containing a composition is stable over extended periods of time of shelf storage, including at least about 6 months, at least about 9 months, at least about 12 months, at least about 15 months, at least about 18 months, or at least about 24 months, or longer. Shelf storage conditions preferably include room temperature, and low to moderate humidity.

A stain-fighting, fabric-softening composition may comprise, may consist essentially of, or may consist of (weight %) about 45% to about 60% of a fabric softening agent, about 0.5% to about 3% of a fragrance, about 25% to about 40% of a bleaching agent, about 7% to about 15% of a bleach activating agent, about 0.5% to about 5% of an enzyme that catalyzes the breakdown of an oil-based stain, and about 0.1% to about 1.5% of an enzyme that catalyzes the breakdown of a protein-based stain and/or a starch-based stain. The stain-fighting, fabric-softening composition more preferably may comprise, may consist essentially of, or may consist of (weight %) about 50% to about 55% of a fabric softening agent, about 1% to about 2% of a fragrance, about 29% to about 33% of a bleaching agent, about 10% to about 13% of a bleach activating agent, about 1% to about 3% of an enzyme that catalyzes the breakdown of an oil-based stain, and about 0.3% to about 1% of an enzyme that catalyzes the breakdown of a protein-based stain and/or a starch-based stain. The stain-fighting, fabric-softening composition more preferably may comprise, may consist essentially of, or may consist of (weight %) about 52% to about 54% of a fabric softening agent, about 1.4% to about 1.6% of a fragrance, about 30% to about 32% of a bleaching agent, about 11% to about 13% of a bleach activating agent, about 1.5% to about 2.5% of an enzyme that catalyzes the breakdown of an oil-based stain, and about 0.4% to about 0.6% of an enzyme that catalyzes the breakdown of a protein-based stain and/or a starch-based stain. The stain-fighting, fabric-softening composition more preferably may comprise, may consist essentially of, or may consist of (weight %) about 53% of a fabric softening agent, about 1.5% of a fragrance, about 31% of a bleaching agent, about 12% of a bleach activating agent, about 2% of an enzyme that catalyzes the breakdown of an oil-based stain, and about 0.5% of an enzyme that catalyzes the breakdown of a protein-based stain and/or a starch-based stain. Each agent is preferably in solid form. The composition, when dissolved in water, preferably effervesces. And, a stain-fighting, fabric softening composition preferably does not include any sodium carbonate.

In some embodiments, a stain-fighting, fabric-softening composition may comprise, may consist essentially of, or may consist of (weight %) about 40% to about 55% of a fabric softening agent, about 0.25% to about 2.5% of a fragrance, about 25% to about 45% of a bleaching agent, about 9% to about 17% of a bleach activating agent, about 0.5% to about 5% of an enzyme that catalyzes the breakdown of an oil-based stain, and about 0.1% to about 1.5% of an enzyme that catalyzes the breakdown of a protein-based stain and/or a starch-based stain. The stain-fighting, fabric-softening composition more preferably may comprise, may consist essentially of, or may consist of (weight %) about 47% to about 51% of a fabric softening agent, about 0.5% to about 1.5% of a fragrance, about 32% to about 36% of a bleaching agent, about 11% to about 15% of a bleach activating agent, about 2% to about 3% of an enzyme that catalyzes the breakdown of an oil-based stain, and about 0.5% to about 0.9% of an enzyme that catalyzes the breakdown of a protein-based stain and/or a starch-based stain. The stain-fighting, fabric-softening composition more preferably may comprise, may consist essentially of, or may consist of (weight %) about 48% to about 50% of a fabric softening agent, about 0.9% to about 1.1% of a fragrance, about 33% to about 35% of a bleaching agent, about 12% to about 13% of a bleach activating agent, about 2.5% to about 2.6% of an enzyme that catalyzes the breakdown of an oil-based stain, and about 0.% to about 0.7% of an enzyme that catalyzes the breakdown of a protein-based stain and/or a starch-based stain. The stain-fighting, fabric-softening composition more preferably may comprise, may consist essentially of, or may consist of (weight %) about 49% of a fabric softening agent, about 1% of a fragrance, about 34% of a bleaching agent, about 12.8% of a bleach activating agent, about 2.6% or about 2.55% of an enzyme that catalyzes the breakdown of an oil-based stain, and about 0.7% or about 0.65% of an enzyme that catalyzes the breakdown of a protein-based stain and/or a starch-based stain. Each agent is preferably in solid form. The composition, when dissolved in water, preferably effervesces. And, a stain-fighting, fabric softening composition preferably does not include any sodium carbonate.

A pouch may contain, for example, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, or about 45% by weight of a bleaching agent. A pouch may contain, for example, about 7%, about 8%, about 9%, about 10%, about 11%, about 12%, about 13%, about 14%, about 15%, about 16%, or about 17% by weight of a bleach activating agent. A pouch may contain, for example, about 0.5%, about 1%, about 1.5%, about 2%, about 2.5%, about 3%, about 3.5%, about 4%, about 4.5%, or about 5% by weight of an enzyme that catalyzes the breakdown of an oil-based stain. A pouch may contain, for example, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, or about 1.5% by weight of an enzyme that catalyzes the breakdown of a protein-based stain and/or a starch-based stain. A pouch may contain, for example, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, or about 60% by weight of a fabric softening agent. A pouch may contain, for example, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%. about 2.1%, about 2.2%, about 2.3%, about 2.4%, about 2.5%, about 2.6%, about 2.7%, about 2.8%, about 2.9%, or about 3% by weight of a fragrance. Each agent is preferably in solid form. The composition, when dissolved in water, preferably effervesces.

Any composition described herein may include buffering agents, antimicrobial agents, and other agents to reduce or eliminate degradation of the composition or on the pouch. The composition may have an acidic, basic, or neutral pH.

Preferably, a stain-fighting composition, a stain-fighting, fabric-softening, and/or a fabric-softening composition does not include any surfactant. In some aspects, however, a composition does include a surfactant that acts as a detergent for cleaning a material. A composition including a surfactant may comprise a cleaning composition, and a surfactant in any cleaning composition described or exemplified herein may be an anionic, cationic, zwitterionic, or nonionic surfactant, or any combination thereof. Anionic and nonionic surfactants are preferred.

A cleaning composition may comprise, may consist essentially of, or may consist of (weight %) about 25% to about 45% of a fabric softening agent, about 0.1% to about 1.5% of a fragrance, about 15% to about 25% of a bleaching agent, about 5% to about 10% of a bleach activating agent, about 0.5% to about 3% of an enzyme that catalyzes the breakdown of an oil-based stain, about 0.1% to about 1% of an enzyme that catalyzes the breakdown of a protein-based stain and/or a starch-based stain, and about 25% to about 45% of a surfactant, including an anionic or non-ionic surfactant. A cleaning composition may comprise, may consist essentially of, or may consist of (weight %) about 32% to about 35% of a fabric softening agent, about 0.5% to about 1% of a fragrance, about 18% to about 21% of a bleaching agent, about 6% to about 8% of a bleach activating agent, about 1% to about 2% of an enzyme that catalyzes the breakdown of an oil-based stain, about 0.3% to about 0.5% of an enzyme that catalyzes the breakdown of a protein-based stain and/or a starch-based stain, and about 35% to about 40% of a surfactant, including an anionic or non-ionic surfactant. A cleaning composition may comprise, may consist essentially of, or may consist of (weight %) about 34% of a fabric softening agent, about 0.7% of a fragrance, about 20% of a bleaching agent, about 7% of a bleach activating agent, about 1.5% of an enzyme that catalyzes the breakdown of an oil-based stain, about 0.4% of an enzyme that catalyzes the breakdown of a protein-based stain and/or a starch-based stain, and about 37% of a surfactant, including an anionic or non-ionic surfactant. Each agent is preferably in solid form. The composition, when dissolved in water, preferably effervesces. And, a cleaning composition preferably does not include any sodium carbonate.

In some embodiments, a cleaning composition may comprise, may consist essentially of, or may consist of (weight %) about 30% to about 50% of a fabric softening agent, about 0.1% to about 2% of a fragrance, about 20% to about 35% of a bleaching agent, about 7% to about 13% of a bleach activating agent, about 1% to about 3% of an enzyme that catalyzes the breakdown of an oil-based stain, about 0.1% to about 1% of an enzyme that catalyzes the breakdown of a protein-based stain and/or a starch-based stain, and about 12% to about 28% of a surfactant, including an anionic or non-ionic surfactant. A cleaning composition may comprise, may consist essentially of, or may consist of (weight %) about 37% to about 42% of a fabric softening agent, about 0.5% to about 1% of a fragrance, about 25% to about 29% of a bleaching agent, about 8% to about 12% of a bleach activating agent, about 1.5% to about 2.5% of an enzyme that catalyzes the breakdown of an oil-based stain, about 0.4% to about 0.6% of an enzyme that catalyzes the breakdown of a protein-based stain and/or a starch-based stain, and about 18% to about 22% of a surfactant, including an anionic or non-ionic surfactant. A cleaning composition may comprise, may consist essentially of, or may consist of (weight %) about 39% to about 40% of a fabric softening agent, about 0.8% of a fragrance, about 27% to about 28% of a bleaching agent, about 10% to about 11% of a bleach activating agent, about 2% of an enzyme that catalyzes the breakdown of an oil-based stain, about 0.5% of an enzyme that catalyzes the breakdown of a protein-based stain and/or a starch-based stain, and about 20% of a surfactant, including an anionic or non-ionic surfactant. Each agent is preferably in solid form. The composition, when dissolved in water, preferably effervesces. And, a cleaning composition preferably does not include any sodium carbonate.

In some embodiments, a cleaning composition may comprise, may consist essentially of, or may consist of (weight %) about 36% to about 52% of a fabric softening agent, about 0.1% to about 2% of a fragrance, about 22% to about 40% of a bleaching agent, about 8% to about 15% of a bleach activating agent, about 1% to about 4% of an enzyme that catalyzes the breakdown of an oil-based stain, about 0.1% to about 1.5% of an enzyme that catalyzes the breakdown of a protein-based stain and/or a starch-based stain, and about 5% to about 30% of a surfactant, including an anionic or non-ionic surfactant. A cleaning composition may comprise, may consist essentially of, or may consist of (weight %) about 42% to about 46% of a fabric softening agent, about 0.7% to about 1.1% of a fragrance, about 29% to about 33% of a bleaching agent, about 10% to about 14% of a bleach activating agent, about 2% to about 3% of an enzyme that catalyzes the breakdown of an oil-based stain, about 0.4% to about 0.8% of an enzyme that catalyzes the breakdown of a protein-based stain and/or a starch-based stain, and about 8% to about 12% of a surfactant, including an anionic or non-ionic surfactant. A cleaning composition may comprise, may consist essentially of, or may consist of (weight %) about 44% of a fabric softening agent, about 0.9% of a fragrance, about 30% to about 31% of a bleaching agent, about 11% to about 12% of a bleach activating agent, about 2.3% of an enzyme that catalyzes the breakdown of an oil-based stain, about 0.6% of an enzyme that catalyzes the breakdown of a protein-based stain and/or a starch-based stain, and about 10% of a surfactant, including an anionic or non-ionic surfactant. Each agent is preferably in solid form. A cleaning composition may comprise, may consist essentially of, or may consist of (weight %) about 44% of a fabric softening agent, about 0.9% of a fragrance, about 30.7% of a bleaching agent, about 11.5% of a bleach activating agent, about 2.3% of an enzyme that catalyzes the breakdown of an oil-based stain, about 0.6% of an enzyme that catalyzes the breakdown of a protein-based stain and/or a starch-based stain, and about 10% of a surfactant, including an anionic or non-ionic surfactant. Each agent is preferably in solid form. The composition, when dissolved in water, preferably effervesces. And, a cleaning composition preferably does not include any sodium carbonate.

A pouch may contain, for example, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, or about 35% by weight of a bleaching agent. A pouch may contain, for example, about 5%, about 6%, about 7%, about 8%, about 9%, about 10%, about 11%, about 12%, or about 13% by weight of a bleach activating agent. A pouch may contain, for example, about 0.5%, about 1%, about 1.5%, about 2%, about 2.5%, or about 3% by weight of an enzyme that catalyzes the breakdown of an oil-based stain. A pouch may contain, for example, about 0.1%, about 0.2%, about 0.3%, about 0.4%, about 0.5%, about 0.6%, about 0.7%, about 0.8%, about 0.9%, or about 1% by weight of an enzyme that catalyzes the breakdown of a protein-based stain and/or a starch-based stain. A pouch may contain, for example, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, or about 50% by weight of a fabric softening agent. A pouch may contain, for example, about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, or about 2% by weight of a fragrance. A pouch may contain, for example, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, or about 45% by weight of a surfactant, including an anionic or non-ionic surfactant. Each agent is preferably in solid form. The composition, when dissolved in water, preferably effervesces.

The invention also features laundry kits. The laundry kits may comprise, for example, a water-soluble pouch containing a stain-fighting composition, a water-soluble pouch containing a fabric-softening composition, a water-soluble pouch containing a stain-fighting, fabric softening composition and/or a water-soluble pouch containing a cleaning composition. The laundry kits may comprise a water soluble pouch containing a stain-fighting composition, a fabric-softening composition, and a cleaning composition in different compartments of the pouch. A stain-fighting composition may be any such composition described herein. A fabric-softening composition may be any such composition described herein. A stain-fighting, fabric-softening composition may be any such composition described herein. A cleaning composition may be any such composition described herein. The kits also comprise instructions for using a pouch in a method for removing stains from laundry or a surface, instructions for using a pouch in a method for softening laundry, and/or instructions for using a pouch in a method for cleaning laundry.

In some aspects, the laundry kits may comprise a water-soluble pouch containing a stain-fighting composition, and/or a water-soluble pouch containing a fabric-softening composition, and/or a water-soluble pouch containing a stain-fighting, fabric-softening composition, and a detergent-containing pouch such as those described in U.S. Pat. No. 6,037,319, or a fragrance-containing pouch such as those described in U.S. application Ser. No. 13/446,119, incorporated by reference herein in its entirety, and instructions for using the pouches in a method for cleaning laundry. In some aspects, the laundry kits may comprise a water-soluble pouch containing a fabric-softening composition and a bleaching agent-containing pouch such as those described in U.S. application Ser. No. 13/446,389, incorporated by reference herein in its entirety, and instructions for using the pouches in a method for cleaning laundry.

The invention also features methods. In some aspects, the methods are employed to remove stains from laundry or a surface, including to bleach/whiten the surface or laundry. In some aspects, the methods are employed to soften laundry. In some aspects, the methods are employed to soften and remove stains and odors from laundry. In some aspects, the methods are employed to clean laundry, including removing stains from and/or bleach/whitening and/or softening the laundry.

In one aspect, the methods comprise adding a water-soluble pouch containing a stain-fighting composition to a volume of water such that exposure of the pouch to the water for a sufficient period of time causes the pouch to dissolve in the water, thereby releasing the contents of the pouch into the water and creating a water solution comprising a stain-fighting composition, contacting laundry in need of stain removal with the water solution for a period of time sufficient to remove stains from the laundry, and rinsing the laundry to remove the water solution. The method may comprise agitating the laundry in the presence of the water solution for a period of time sufficient to remove stains from the laundry. In some preferred aspects, the water is in the drum of a washing machine, or is being added to the drum of a washing machine, for example, during a wash cycle or a filling cycle. In some aspects, the water solution further comprises a detergent such as a laundry detergent. The stain-fighting composition in the pouch may be any such composition described herein. The period of time may be measured in seconds or minutes, and may depend, for example, on a particular washing cycle, or on the temperature of the water, or the degree or type of stains on the laundry.

In one aspect, the methods comprise adding a water-soluble pouch containing a fabric-softening composition or containing a stain-fighting, fabric-softening composition to a volume of water such that exposure of the pouch to the water for a sufficient period of time causes the pouch to dissolve in the water, thereby releasing the contents of the pouch into the water and creating a water solution comprising a fabric-softening composition or a water solution comprising a stain-fighting, fabric softening composition, contacting laundry in need of softening with the water solution for a period of time sufficient to soften the laundry, and rinsing the laundry to remove the water solution. The method may comprise agitating the laundry in the presence of the water solution for a period of time sufficient to soften the laundry. In some preferred aspects, the water is in the drum of a washing machine, or is being added to the drum of a washing machine, for example, during a wash cycle or a filling cycle. In some aspects, the water solution further comprises a detergent such as a laundry detergent. In some aspects, the water solution further comprises a stain-fighting composition, including those described herein (which may be added to the water solution by way of a pouch). The fabric-softening composition or stain-fighting, fabric-softening composition contained in the pouch may be any such composition described herein. The period of time may be measured in seconds or minutes, and may depend, for example, on a particular washing cycle, or on the temperature of the water, or the desired level of softness to be imparted to the laundry.

In one aspect, the methods comprise adding a water-soluble pouch containing a cleaning composition to a volume of water such that exposure of the pouch to the water for a sufficient period of time causes the pouch to dissolve in the water, thereby releasing the contents of the pouch into the water and creating a water solution comprising a cleaning composition, contacting laundry in need of cleaning with the water solution for a period of time sufficient to clean the laundry, and rinsing the laundry to remove the water solution. The method may comprise agitating the laundry in the presence of the water solution for a period of time sufficient to clean the laundry. In some preferred aspects, the water is in the drum of a washing machine, or is being added to the drum of a washing machine, for example, during a wash cycle or a filling cycle. The cleaning composition in the pouch may be any such composition described herein. The period of time may be measured in seconds or minutes, and may depend, for example, on a particular washing cycle, or on the temperature of the water, or the degree or type of stains on the laundry.

In such methods, a stain-fighting composition, a stain-fighting, fabric softening composition, a fabric softening composition, or a cleaning composition may be any such composition described or exemplified herein. Any constituent of such a composition may be any constituent described or exemplified.

The invention is not limited to the embodiments described and exemplified above, but is capable of variation and modification within the scope of the appended claims.

We claim:

1. A water-soluble pouch, comprising a body comprising polyvinyl alcohol and defining a container portion containing a stain-fighting composition comprising about 60% to about 76% by weight of a bleaching agent in solid form, about 20% to about 30% by weight of a bleach activating agent in solid form, about 1% to about 9% of an enzyme that catalyzes the breakdown of an oil-based stain in solid form, and about 0.5% to about 2.5% of an enzyme that catalyzes the breakdown of a protein-based stain or a starch-based stain in solid form, wherein the container portion has a single layer having an internal surface contacting the stain-fighting composition, and having an external surface which is the outermost portion of the pouch, and wherein the container portion does not contain any surfactant.

2. The pouch of claim 1, wherein the stain-fighting composition comprises about 65% to about 70% of a bleaching agent in solid form, about 24% to about 26% of a bleach activating agent in solid form, about 4% to about 6% of an enzyme that catalyzes the breakdown of an oil-based stain in solid form, and about 1% to about 1.5% of an enzyme that catalyzes the breakdown of a protein-based stain or a starch-based stain in solid form.

3. The pouch of claim 1, wherein the stain-fighting composition comprises about 68% of a bleaching agent in solid form, about 26% of a bleach activating agent in solid form, about 5% of an enzyme that catalyzes the breakdown of an oil-based stain in solid form, and about 1% of an enzyme that catalyzes the breakdown of a protein-based stain or a starch-based stain in solid form.

4. The pouch of claim 1, wherein the stain-fighting composition comprises about 68.1% of a bleaching agent in solid form, about 25.5% of a bleach activating agent in solid form, about 5.1% of an enzyme that catalyzes the breakdown of an oil-based stain in solid form, and about 1.3% of an enzyme the catalyzes the breakdown of a protein-based stain or a starch-based stain in solid form.

5. The pouch of claim 1, wherein the bleaching agent is sodium percarbonate.

6. The pouch of claim 1, wherein the bleach activating agent is tetra-acetylethylenediamine.

7. The pouch of claim 1, wherein the enzyme that catalyzes the breakdown of an oil-based stain comprises a lipase.

8. The pouch of claim 1, wherein the enzyme that catalyzes the breakdown of a protein-based stain or a starch-based stain comprises a protease, an amylase, a cellulase, or a combination thereof.

9. The pouch of claim 1, wherein the stain-fighting composition is contained in the pouch in an amount sufficient for one regular laundry cycle.

10. The pouch of claim 1, wherein the stain-fighting composition is contained in the pouch in an amount sufficient for one high efficiency laundry cycle.

11. A kit, comprising the pouch of claim 1 and instructions for using the pouch in a method for removing stains in laundry or on a surface.

12. The kit of claim 11, further comprising a second water-soluble pouch comprising a body comprising polyvinyl alcohol and defining a container portion containing a fabric-softening composition comprising about 94% to about 99% by weight of a fabric-softening agent in solid form, and about 1% to about 6% by weight of a fragrance absorbed into the fabric softening agent, wherein the container portion has a single layer having an internal surface contacting the fabric-softening composition, and having an external surface which is the outermost portion of the second pouch, and wherein the container portion does not contain any surfactant.

13. A method for removing stains and odors from laundry, comprising adding the pouch of claim 1 to a volume of water such that the pouch dissolves in the water thereby creating a water solution comprising a stain-fighting composition, contacting laundry in need of stain-removal with the water solution for a period of time sufficient to remove stains from the laundry, and after the period of time has elapsed, rinsing the laundry to remove the water solution from the laundry.

14. A water-soluble pouch, comprising a body comprising polyvinyl alcohol and defining a container portion containing a stain-fighting, fabric-softening composition comprising about 32% to about 36% by weight of a bleaching agent in solid form, about 11% to about 15% by weight of a bleach activating agent in solid form, about 2% to about 3% of an enzyme that catalyzes the breakdown of an oil-based stain in solid form, about 0.5% to about 0.9% of an enzyme that catalyzes the breakdown of a protein-based stain or a starch-based stain in solid form, about 47% to about 51% by weight of a fabric-softening in solid form, and about 0.5% to about 1.5% by weight of a fragrance absorbed into the fabric softening agent, wherein the container portion has a single layer having an internal surface contacting the stain-fighting, fabric-softening composition, and having an external surface which is the outermost portion of the pouch, wherein the container portion does not contain any surfactant, and wherein the fabric softening agent comprises particles from about 1 mm to about 3 mm in size, and the particles are optionally colored with a dye.

15. The pouch of claim 14, wherein the stain-fighting, fabric softening composition comprises about 34% by weight of a bleaching agent in solid form, about 13% by weight of a bleach activating agent in solid form, about 2.55% by weight of an enzyme that catalyzes the breakdown of an oil-based stain in solid form, about 0.65% of an enzyme that catalyzes the breakdown of a protein-based stain or a starch-based stain in solid form, about 49% by weight of a fabric softening agent in solid form, and about 1% by weight of a fragrance absorbed into the fabric softening agent.

16. The pouch of claim 14, wherein the solid fabric softening agent comprises bentonite or zeolite.

17. The pouch of claim 14, wherein the stain-fighting, fabric softening composition is contained in the pouch in an amount sufficient for one regular laundry cycle.

18. The pouch of claim 14, wherein the stain-fighting, fabric-softening composition is contained in the pouch in an amount sufficient for one high efficiency laundry cycle.

19. The pouch of claim 14, wherein the bleaching agent is sodium percarbonate and the bleach activating agent is tetra-acetylethylenediamine.

20. The pouch of claim 14, wherein the enzyme that catalyzes the breakdown of an oil-based stain comprises a lipase, and the enzyme that catalyzes the breakdown of a protein-based stain or a starch-based stain comprises a protease, an amylase, a cellulase, or a combination thereof.

21. A kit, comprising the pouch of claim 14 and instructions for using the pouch in a method for softening and removing stains and odors from laundry.
